(19) United States
(12) Patent Application Publication
(10) Pub. No.: US 2010/0140273 A1
(43) Pub. Date: Jun. 10, 2010

(54) LIGHTWEIGHT EXPANSION VESSELS

(75) Inventors: Ulrich Endemann, Bockemheim (DE); May Michael Brockmueller, Neustadt (DE); Hans Barthelmess, Reutlingen (DE); Harald Kroeger, Boehl-Iggelheim (DE); Angelika Homes, Laudenbach (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/063,784

(22) PCT Filed: Aug. 3, 2006
(86) PCT No.: PCT/EP06/65042

§ 371 Date: Feb. 14, 2008

(30) Foreign Application Priority Data
Aug. 17, 2005 (DE) 102005039161.3

(51) Int. Cl. B65D 25/04; B65D 25/00; B29C 63/10; B65B 7/00

(52) U.S. Cl. 220/553; 220/720; 156/187; 156/69

(57) ABSTRACT

The invention relates to an expansion vessel for closed heating, cooling, drinking-water, or solar systems, with two spaces separated from one another via a separator, wherein the casing of the vessel

i) has an inner surface composed of polyethylene terephthalate, polyamide, polybutylene terephthalate, polyacetal, polyvinyl chloride, polyacrylonitrile, polystyrene copolymer, ethylene-vinyl alcohol, polyvinyl alcohol, polyether sulfone, or polysulfone, and

ii) has a wound outer surface composed of oriented fibers.

The invention relates to an expansion vessel for closed heating, cooling, drinking-water, or solar systems, with two spaces separated from one another via a separator, wherein the casing of the vessel
i) has an inner surface composed of polyethylene terephthalate, polyamide, polybutylene terephthalate, polyacetal, polyvinyl chloride, polyacrylonitrile, polystyrene copolymer, ethylene-vinyl alcohol, polyvinyl alcohol, polyether sulfone, or polysulfone, and
ii) has a wound outer surface composed of oriented fibers.

Expansion vessels for, by way of example, hot-water heating systems are well known (see, by way of example, DE 1667018 and DE 2641474, and also IKZ-Haustechnik issue dated Feb. 1, 2004 pp. 24-28).

When water is heated and cooled in heating, cooling, and drinking-water systems, its volume changes. In order to permit compensation for these changes, “membrane pressure expansion vessels” are currently used and are composed of metal. The membrane separates a space filled with gas (mostly inert gas) from a space filled with water. DE 102 35 061 describes expansion vessels in which the two spaces have been separated by a piston rather than by a membrane. The casings of these expansion vessels have been manufactured from metal. The production of the vessels including the piston is expensive, and because of the high dead weight of the vessels transport costs are high. Furthermore, corrosion problems arise in steel vessels.

Replacement of a metal jacket by a plastics jacket would lead to high wall thicknesses of the vessels. The main reason for this is the low level of gas-barrier action of most standard plastics. A consequence of this is that the precompression pressure required in the vessel/system is not retained, but instead falls. If the precompression pressure in the vessel is to be retained over a long period, the vessels have to be provided with a high wall thickness. The materials costs associated with the high wall thicknesses make this type of design uneconomic.

DE 40 08 026 describes membrane expansion vessels accessible by means of injection-molding processes. DE 40 08 026 does not provide any detail concerning the problem of the high gas permeability of most standard plastics. Nor does that specification give any indication as to which plasticized plastic is suitable for expansion vessels.

It was therefore an object of the present invention to provide an expansion vessel with low wall thicknesses which at the same time has good gas-barrier properties and high resistance to hydrolysis and which counteracts the creep tendency of the plastic.

Surprisingly, the object has been achieved via the expansion vessels defined at the outset, the casings of which
i) have an inner surface composed of polyethylene terephthalate, polyamide, polybutylene terephthalate, polyacetal, polyvinyl chloride, polyacrylonitrile, polystyrene copolymer, ethylene-vinyl alcohol, polyvinyl alcohol, polyether sulfone, or polysulfone, and
ii) have a wound outer surface composed of oriented fibers.

The following thermoplastics: polyethylene terephthalate, polyamide, polybutylene terephthalate, polyacetal, polyvinyl chloride, polyacrylonitrile, polystyrene copolymer, ethylene-vinyl alcohol, polyvinyl alcohol, polyether sulfone, or polysulfone have a high level of barrier action with respect to various gases. Nitrogen gas is often used as inert gas in heating systems and is particularly relevant here. Particularly suitable materials for expansion vessels are polyethylene terephthalate; polyamides, in particular nylon-6 and nylon-6,6; polyacrylonitrile; polystyrene copolymer (such as SAN—the higher the acrylonitrile content, the higher the level of barrier property of the copolymer, and an acrylonitrile content greater than 35% by weight has proven advantageous); ethylene-vinyl alcohol, polyvinyl alcohol, and polyacetal polyoxymethylene). Particular preference is given to thermoplastics such as polyethylene terephthalate, polyamide, SAN and polyacetal.

The abovementioned materials have further advantages over the standard plastic polypropylene. They can be used at relatively high temperatures (higher possible long-term service temperatures) and they have better mechanical properties, such as strength, stiffness, and scratch resistance.

The thermoplastics used can be unreinforced or fiber-reinforced. For reinforcement, short fibers, medium-length fibers, or long fibers can be used, for example those mentioned in K. Stoeckhert, Kunststofflexikon [Plastics Encyclopedia], Carl Hanser Verlag.

Other auxiliaries, such as lubricants or fillers, can moreover be added to the thermoplastics.

The winding base (winding core) used generally comprises a pipe produced via extrusion (inner surface. i)). In order to reduce materials costs, the wall thickness of the inner surface is generally from 0.5 to 5 mm. A wall thickness of from 1 to 3 mm is preferred.

Neither the ability of the inner surface to withstand pressure nor its gas-barrier property is generally sufficient to meet all of the requirements placed upon the casing of an expansion vessel. This applies particularly when, for economic reasons, the intention is to produce vessels with very low wall thicknesses.

The inner surface is therefore surrounded by a winding of oriented fibers. This produces a second outer surface which improves the ability of the casing to withstand pressure, and its creep property and gas-barrier property.

By way of example, the casing is surrounded by winding on-line via peripherally runing rollers, using glass fiber strands. The winding process can take place round the circumference at various angles and also longitudinally. The fibers/tapes/strands are laid very close to one another and also possibly on top of one another, in order to achieve maximum barrier action. The free surface area of the plastics pipe in contact with the environment is substantially reduced and thus permeation is inhibited. The pressure is retained. The fibers/strips should have maximum impermeability to diffusion of gases.

The most cost-effective process is likely to be Profil-Armierungs-Ziehen [Profile-reinforcement-drawing] (PAZ, p. 11. National Symposium of SAMPE Deutschland e.V. in 2005). This PAZ process places two manufacturing processes which have proven successful derived from the sectors of thermoplastics processing (extrusion) and fiber-composite manufacture (the winding process) in series. In the third step of the process, the fibers are impregnated and consolidated to give a pipe having continuous fiber reinforcement.

The winding process can also take place after the pipes have been sawn to the desired dimension, in a specialized winding unit. The fibers may have been previously impregnated with plastic via pultrusion. Local heating of pipe and fiber can then achieve bonding to the pipe.

The following materials are suitable for the winding process:

Fibers, fiber strands, or tapes, e.g. those based on glass fibers, carbon fibers, aramid fibers, natural fibers, or PA fibers. It can also be advantageous to use hybrid fibers composed of various materials. Glass fibers are preferred, and continuous-filament fibers composed of glass are particularly preferred.

Thin strips (tapes) composed of metal, such as aluminum, or of materials with gas-barrier action, such as ethylene-vinyl alcohol or polyvinyl alcohol, can likewise be applied by the winding technique.

For the pultrusion process, it is preferable to use plastics capable of thermoplastic processing. In particular, care is taken that the material is compatible with the thermoplastic utilized to produce the inner surface, in order to permit achievement of good adhesion between inner and outer surface.

The wall thickness of the outer layer is highly dependent on the fibers used. From 1 to 20 layers of fibers is/are generally applied as outer layer (the average fiber diameter usually being from 5 to 30 micrometers).

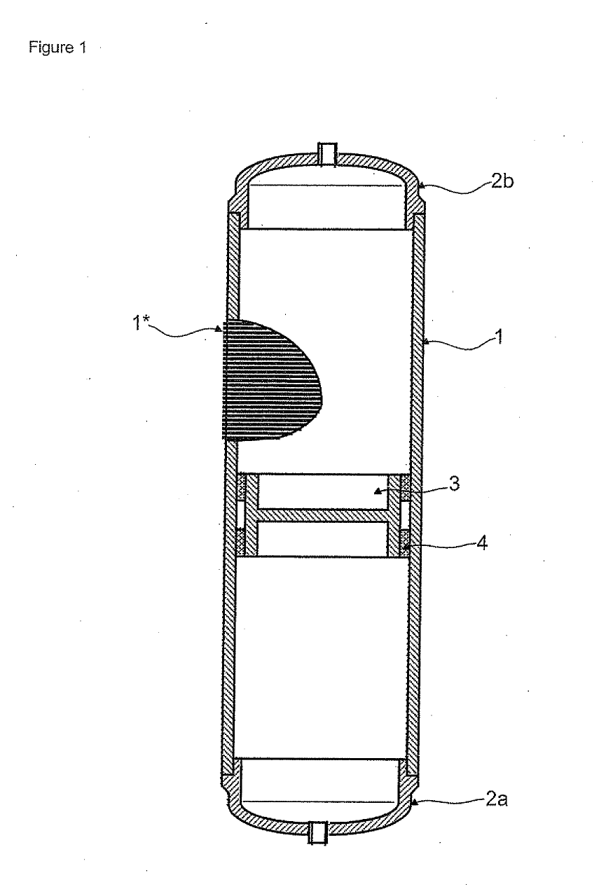

FIG. 1 shows one preferred, membrane-free embodiment of the inventive expansion vessel.

The casing is in essence composed of a pipe produced via extrusion and surrounded by a fiber winding, as described in claim 1. The pipe is cut to length as a function of the vessel volume required. The pipe has a surrounding winding of fiber strands/tapes/strips provided before the production process is complete, or subsequently. The number of layers and the angle of winding can vary here.

Two caps (2a and 2b) preferably produced via injection molding and preferably composed of a material identical with that of the inner surface of the pipe (1) cap the pipe. The caps have preferably been injection molded, in order to permit integration of required attachment systems. One cap has to have an attachment system for a valve for filling with, and emptying of, gas, and the other cap has to have an inlet- and outlet-attachment system for the water content.

The vessels have slidable separators (pistons, floats, or the like) in the pipe which separate the gas space from the water space. In various structural variants, this can by way of example be designed as described in DE 102 35 061. Other embodiments are given below:
the separator is composed of a compact plastic, with or without gasket;
the separator is composed of a foamed plastic, with or without gasket;
the separator is composed of a deformable “cushion” in contact with the walls of the pipes, e.g. foam-, liquid-, or gel-filled;
separation by way of a liquid which extends within the boundary layer;
slidable separator layer composed of butyl rubber.

The advantages of the preferred embodiment are as follows:
the design of the pipe (1) and of the caps (2a and 2b) using thermoplastics with good gas-barrier performance permits avoidance of any fall-off from the precompression pressure in the system;
the tendency of the plastic toward creep is inhibited via winding;
winding increases ability to withstand pressure;
the pipe (1) is manufactured via extrusion (continuously, no die change, very small inventory);
after the process of winding around the pipe, another layer of the thermoplastic used in the inner layer can be applied; this eliminates break-away of the fibers; the addition of color pigments to the plastic can color the pipe in a desired color, and the painting process is saved;
caps (2a and 2b) with the same geometry are used for containers of different size (very small number of injection molds);
the piston/float separator requires less maintenance than a membrane;
a. modular—can easily be assembled for various volumes;
b. recyclable—if separator and container have been produced from the same material or from a compatible material, the materials of used containers can simply be recycled;
c. corrosion-resistant, because produced from plastics.

1-10. (canceled)

11. An expansion vessel for closed heating, cooling, drinking-water, or solar systems, the expansion vessel having two interior spaces separated from one another via a separator and comprising:
a casing having an inner surface composed of a thermorplastic and an outer surface composed of a winding of oriented fibers.

12. The expansion vessel according to claim 11, wherein the thermoplastic is selected from the group of polyethylene terephthalate, polyamide, polybutylene terephthalate, polyacetal, polyvinyl chloride, polyacrylonitrile, polystyrene copolymer, ethylene-vinyl alcohol, polyvinyl alcohol, polyether sulfone, and polysulfone,

13. The expansion vessel according to claim 11, wherein the inner surface has a wall thickness of about 0.5 to 5 mm and the outer surface has a wall thickness corresponding to from one to six windings of the fibers around the casing.

14. The expansion vessel according to claim 11, wherein the thermoplastic of the inner surface is fiber-reinforced.

15. The expansion vessel according to claim 11, wherein the fibers of the outer surface are selected from the group of glass fibers, carbon fibers, textile fibers, natural fibers, aramid fibers, hybrid fibers, thermoplastic fibers, and metal tapes.

16. The expansion vessel according to claim 11, wherein the fibers of the outer surface comprise continuous-filament fibers.

17. The expansion vessel according to claim 11, wherein the fibers of the outer surface are composed of glass fibers.

18. An expansion vessel comprising:
an extruded plastics pipe composed of a thermoplastic, the pipe having two interior spaces separated form one another by a separator;
a winding of oriented fibers surrounding the pipe; and
two injection-molded end caps, each end cap sealing respective ends of the pipe.

19. The expansion vessel according to claim 18, wherein the extruded plastics pipe and the injection-molded end caps are composed of the same material.

20. A process of producing a casing of an expansion vessel, the process comprising:
producing a pipe by means of extruding a thermoplastic material;
surrounding the pipe with a winding having a specific fiber orientation, and
coating the pipe with one of an outer layer, impregnation layer, color layer, or protective layer.

21. A process of producing a casing of an expansion vessel, the process comprising:
producing a pipe by means of extruding a thermoplastic material;
surrounding the pipe with a winding having a specific fiber orientation, and
sealing each end of the pipe with an injection-molded end cap.
